(19) United States
(12) Patent Application Publication
(10) Pub. No.: US 2017/0285338 A1
(43) Pub. Date: Oct. 5, 2017

(54) VEHICULAR PROJECTION DISPLAY APPARATUS

(71) Applicant: YAZAKI CORPORATION, Tokyo (JP)

(72) Inventors: Noriaki Narushima, Shizuoka (JP); Takeyoshi Watanabe, Shizuoka (JP)

(21) Appl. No.: 15/433,247

(22) Filed: Feb. 15, 2017

(30) Foreign Application Priority Data
Mar. 29, 2016 (JP) 2016-065763

(51) Int. Cl. G02B 27/01; B60K 35/00; G09G 3/00

(52) U.S. Cl. CPC G02B 27/0101; G09G 3/002; B60K 35/00; G09G 2380/10; B60K 2350/2052; B60K 2350/1056; B60K 2350/2017

(57) ABSTRACT

A vehicular projection display apparatus includes: an intermediate image forming optical member; a display device disposed to project light including a display image to the intermediate image forming optical member, and to form an intermediate image as a virtual image or a real image, and an HUD optical system which receives the light of the intermediate image formed by the intermediate image forming optical member, which guides the light to a reflecting face of a windshield of a vehicle or a light reflecting member in a vicinity of the windshield, and which projects the light to allow the display image to be visually recognized as a virtual image at a predetermined eye point. The intermediate image forming optical member forms the intermediate image in a state in which at least part of the intermediate image is curved from a flat plane with respect to the display device.

### CROSS-REFERENCE TO RELATED APPLICATION(S)

This application is based on and claims priority from Japanese Patent Application (Application No. 2016-065763) filed on Mar. 29, 2016, the entire contents of which are incorporated herein by reference.

### BACKGROUND

### 1. Field of the Invention

The present invention relates to a vehicular projection display apparatus for performing display by using, for example, the light reflection of the windshield (window glass) provided ahead of the driver in a vehicle.

### 2. Description of Related Art

In the case that information required by the driver in a vehicle, such as vehicle speed and guide display on a navigation system, is displayed, a head-up display (HUD) apparatus has been used in some cases to improve the visibility of the display at the time when the driver looks at the display during driving.

In a head-up display apparatus for general vehicles, an optical path is formed so that the image of light including various kinds of information to be displayed is projected from an HUD unit to a front windshield or a reflection plate referred to as a combiner and the light reflected by the front windshield or the like is directed to the viewpoint of the driver. Hence, the driver can visually recognize the display of the HUD unit reflected onto the windshield or the like as a virtual image while visually recognizing scenes ahead of the vehicle through the front windshield at the same time. That is to say, the driver can visually recognize various kinds of information by virtue of the display of the HUD unit while maintaining an ordinary driving state without moving the line of sight.

However, in an apparatus for projecting a display image by using the reflection of light on the face of the windshield as in the case of the HUD unit, distortion may occur in the image to be visually recognized by the driver. In other words, distortion occurs in the image because the image is deformed by the reflection of light on the face of the windshield in an oblique direction and because the face itself of the windshield has a gradually curved shape. Furthermore, since the curvature and the inclination angle of the windshield with respect to the horizontal plane (or the vertical plane) are different depending on the position on the windshield, various kinds of distortion may occur in the display image to be visually recognized in accordance with situations, thereby adversely affecting visibility. Moreover, in the case that the HUD unit projects an image using a magnification optical system, aberration occurs due to the influence of the curved faces of the lenses and mirrors included in this optical system.

It has been known that aberration occurring due to the windshield and the HUD optical system of a vehicle is a factor of the distortion occurring in a display image (virtual image). Furthermore, among various kinds of aberration, the aberration caused by the three-dimensional distortion of a display image (virtual image) due to “image face curvature” is assumed to be a factor of lowering display quality.

For the correction of this kind of distortion in the display image, for example, a display system in which an aspherical mirror is adopted in its optical system is available. In addition, there is a case in which an image having been distorted beforehand is displayed on the display face of a display device so that a desired image (virtual image) is obtained.

Furthermore, a technology for correcting the three-dimensional distortion of a virtual image due to the image face curvature has been disclosed, for example, in JP-A-2013-25205. In the head-up display apparatus according to JP-A-2013-25205, the laser light emitted from a laser scanner is projected to the image forming face of a screen. The light of the image on the image forming face is reflected while being diffused and is directed to the eye point via a concave mirror and the projection face of the windshield. Moreover, the image forming face of the screen has a convex shape being curved in the horizontal direction of an image to be formed, and this shape is used to correct the image face curvature of the virtual image due to the curvature of the reflecting face of the concave mirror and the curvature of the projection face of the windshield.

In addition, in the image display apparatus according to JP-A-2010-224016, a plano-convex cylindrical lens is disposed at a position adjacent to the display face of a display device for displaying two-dimensional images, and the image display apparatus is configured so that the apparent curvature of the display face due to the optical action of this cylindrical lens and the image face curvature occurring due to a concave mirror are canceled with each other, whereby the image face curvature is reduced.

Moreover, the vehicular display apparatus according to JP-A-2004-130892 discloses a technology capable of performing positional adjustment in the visual recognition range inside an eye range.

### SUMMARY

In the case that the aspherical mirror is adopted as the reflecting mirror of the HUD optical system, the aberration occurring due to the characteristics of the reflecting mirror itself can be reduced and the aberration occurring due to the characteristics of the reflecting face of the windshield of a vehicle can be corrected. However, the image face curvature, i.e., three-dimensional distortion, cannot be corrected even if the aspherical mirror is used.

Furthermore, in the case that the image to be displayed on the display face of the display device built in the HUD unit has been distorted beforehand, the distortion in the virtual image to be visually recognized at the eye point can be corrected to some extent. However, since the display face of the display device is generally flat, even if the image to be displayed on the display face has been distorted, only the planar distortion of the virtual image to be displayed can be corrected. That is to say, since the distortion in the depth direction of the image (the direction of the optical axis at the time when the image is projected) cannot be corrected, the three-dimensional distortion of the display image (virtual image) due to the “image face curvature” cannot be corrected.

In the case of the screen to which an image is projected is adopted as in the case of JP-A-2013-25205, the face of the screen can be curved. Hence, the curved shape of the face of the screen can reduce the three-dimensional distortion of the display image (virtual image) due to the “image face curvature” occurring due to the characteristics of the windshield or the like.

However, since the face of the screen to be adopted in a projector or the like is a diffusion face, the light of the display image to be projected to the screen is diffused. As a result, there is a problem that the utilization efficiency of the light is degraded and extra power consumption and heat generation occur in the light source. Furthermore, in the case that external light, such as solar light, enters the face of the screen, since this external light scatters, there is a problem that the visibility of display light is degraded.

Still further, also in the case that the technology according to JP-A-2010-224016 is adopted, the three-dimensional distortion due to the image face curvature can be reduced. However, since the cylindrical lens is disposed at a position adjacent to the display face of the display device in the technology according to JP-A-2010-224016, the HUD optical system uses a ray of light having a large emission angle with respect to the display face of the display device. Hence, in the case that a display device having a small viewing angle and having luminance characteristics varying significantly depending on the viewing angle, such as a TN liquid crystal (twisted nematic liquid crystal) display device, is used, it is difficult to obtain excellent luminance characteristics in the virtual image display of the HUD unit. Hence, a concave Fresnel lens is disposed between the display face of the display device and the flat face of the cylindrical lens to improve display characteristics in the technology according to JP-A-2010-224016. However, it is inevitable that the structure of the image display apparatus becomes complicated.

The present invention has been made in consideration of the above-mentioned circumstances, and an object of the present invention is to provide a vehicular projection display apparatus capable of reducing the influence of the “image face curvature” occurring due to the windshield and other components in the HUD optical system without using a screen and also capable of improving display quality without making the structure of the apparatus complicated.

Aspects of a vehicular projection display apparatus are described as follows:

(1) A vehicular projection display apparatus including:

an intermediate image forming optical member including at least one of an optical lens, a convex mirror and a concave mirror and having a face for transmitting or reflecting light;

a display device disposed to project light including a display image to the intermediate image forming optical member, and to form an intermediate image of the display image as a virtual image at a position closer to the intermediate image forming optical member than a focus of the intermediate image forming optical member or to form the intermediate image as a real image at a position farther away from the intermediate image forming optical member than the focus of the intermediate image forming optical member, and

an HUD optical system which receives the light of the intermediate image formed by the intermediate image forming optical member via the intermediate image forming optical member, which guides the light to a reflecting face of a windshield of a vehicle or a light reflecting member in a vicinity of the windshield, and which projects the light to allow the display image of the light reflected by the reflecting face to be visually recognized as a virtual image at a predetermined eye point,

wherein the intermediate image forming optical member forms the intermediate image in a state in which at least part of the intermediate image is curved from a flat plane with respect to the display device.

(2) The vehicular projection display apparatus according to the above-mentioned item (1),

wherein the HUD optical system includes a concave mirror which magnifies an image to be projected,

wherein the intermediate image forming optical member includes a convex mirror having a shape in which a central portion of a face opposing a concave face of the concave mirror of the HUD optical system protrudes with respect to a peripheral portion thereof, and the intermediate image formed by the intermediate image forming optical member is a virtual image, and

wherein a curved state of the intermediate image has a shape which corrects an aberration of image face curvature occurring due to an influence of at least one of the curved face included in the HUD optical system and a face shape of the windshield of the vehicle.

(3) The vehicular projection display apparatus according to the above-mentioned item (1),

wherein the HUD optical system includes a first concave mirror which magnifies an image to be projected,

wherein the intermediate image forming optical member includes a second convex mirror having a shape in which a peripheral portion of a face opposing a concave face of the first concave mirror protrudes more than a central portion thereof, and the intermediate image formed by the intermediate image forming optical member is a real image, and

wherein a curved state of the intermediate image has a shape which corrects an aberration of image face curvature occurring due to an influence of at least one of a curved face included in the HUD optical system and a face shape of the windshield of the vehicle.

(4) The vehicular projection display apparatus according to the above-mentioned item (1),

wherein the HUD optical system includes a concave mirror which magnifies an image to be projected,

wherein the intermediate image forming optical member includes one or more convex faces having a shape in which a central portion thereof protrudes more than a peripheral portion thereof, and the intermediate image formed by the intermediate image forming optical member is a real image, and

wherein a curved state of the intermediate image has a shape which corrects an aberration of image face curvature occurring due to an influence of at least one of a curved face included in the HUD optical system and a face shape of the windshield of the vehicle.

(5) The vehicular projection display apparatus according to any one of the above-mentioned items (1) to (4),

wherein a position in which the intermediate image forming optical member is disposed and an optical characteristics of the intermediate image forming optical member are determined such that the image formed at the position of the eye point via the optical system including a reflecting face of the windshield or in the vicinity thereof, the HUD optical system, and the intermediate image forming optical member is disposed in the vicinity of a plane including the focus of the intermediate image forming optical member.

With the vehicular projection display apparatus configured as described in the above-mentioned item (1), since the intermediate image is formed in a curved state, “image face curvature” occurring due to the windshield of the vehicle and the HUD optical system can be corrected. Furthermore, since the intermediate image forming optical member transmits or reflects the light of the intermediate image and directly transfers the light to the HUD optical system, optical transfer efficiency is improved. Moreover, since a light dispersing screen is not used, the vehicular projection display apparatus is hardly affected by the influence of external light, such as solar light. What's more, since the intermediate image forming optical member is not necessarily required to be disposed in the vicinity of the display device, light having a small emission angle and emitted from the display face of the display device can be used, and the deterioration in the luminance characteristics of the image to be displayed can be prevented.

With the vehicular projection display apparatus configured as described in the above-mentioned item (2), the intermediate image formed by the convex mirror serving as the intermediate image forming optical member is a virtual image being curved in the same direction as that of the concave mirror of the HUD optical system. Hence, the aberration of the image face curvature occurring due to the influence of the curved face of the concave mirror of the HUD optical system can be corrected by the curved shape of the intermediate image.

With the vehicular projection display apparatus configured as described in the above-mentioned item (3), the intermediate image formed by the second concave mirror serving as the intermediate image forming optical member is a real image being curved in the same direction as that of the first concave mirror of the HUD optical system. Hence, the aberration of the image face curvature occurring due to the influence of the curved face of the first concave mirror of the HUD optical system can be corrected by the curved shape of the intermediate image.

With the vehicular projection display apparatus configured as described in the above-mentioned item (4), the intermediate image formed by the convex face of the intermediate image forming optical member is a real image being curved in the same direction as that of the concave mirror of the HUD optical system. Hence, the aberration of the image face curvature occurring due to the influence of the curved face of the concave mirror of the HUD optical system can be corrected by the curved shape of the intermediate image.

With the vehicular projection display apparatus configured as described in the above-mentioned item (5), the light having a small emission angle and emitted from the display face of the display device can form an optical path so that an image is formed in the vicinity of the eye point. Hence, the luminance characteristics of the image to be projected can be maintained in an excellent state even in the case that the viewing angle of the display device is small.

With the vehicular projection display apparatus according to the aspects of the present invention, the influence of the “image face curvature” occurring due to the windshield and other components in the HUD optical system can be reduced without using a screen. Furthermore, the display quality of the apparatus can be improved while suppressing the increase in the number of components constituting the apparatus.

The aspects of the present invention has been described above briefly. Moreover, the details of the present invention will be further clarified by reading the descriptions of the modes (hereafter referred to as “embodiments”) for embodying the invention to be described below referring to the accompanying drawings.

### BRIEF DESCRIPTION OF THE DRAWINGS

FIG. 1 is a view showing a general configuration of a vehicular projection display apparatus and optical paths in the apparatus according to an embodiment of the present invention;

FIG. 2 is an optical path view showing the relationship among the convex mirror shown in FIG. 1, an object and an intermediate image;

FIG. 3 is an optical path view showing the relationship among a concave mirror to be used in Modification 1, an object and an intermediate image;

FIG. 4 is an optical path view showing the relationship among a convex lens to be used in Modification 2, an object and an intermediate image; and

FIG. 5 is an optical path view in a vehicular projection display apparatus according to Modification 2.

### DETAILED DESCRIPTION

Specific embodiments according to the present invention will be described below referring to the respective accompanying drawings.

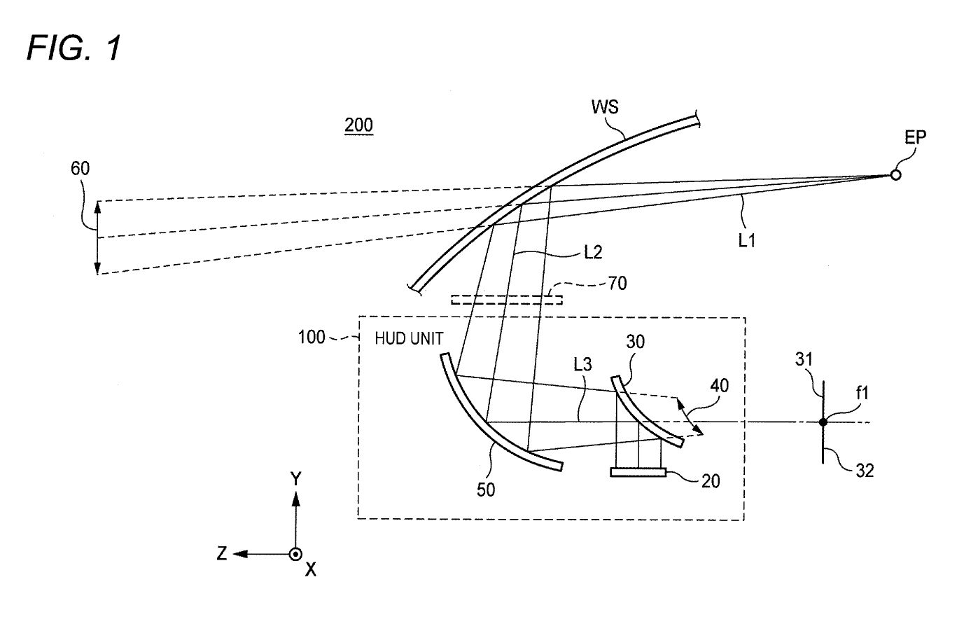

First, a configuration example of a vehicular projection display apparatus will be described. FIG. 1 shows the positional relationship of respective components of the vehicular projection display apparatus in the case that a vehicle equipped with the vehicular projection display apparatus, i.e., an HUD unit 100, is viewed from its side.

The HUD unit 100 shown in FIG. 1 is accommodated inside the dashboard of the vehicle and is configured so as to be able to emit light including a display image upward from an opening section 70 formed in part of the upper face of the dashboard.

A display device 20, a convex mirror 30, a concave mirror 50 and a display control section, not shown, are provided inside the HUD unit 100. The display device 20 may be a display device, such as a transmission liquid crystal display panel, or a projector incorporating a light source and an optical system for projecting display light and having a screen at the position of the display device 20 shown in FIG. 1 although such a display device and a projector are not shown.

The display device inside the display device 20 has a display face capable of displaying any two-dimensional images. In the case of a general display device, its display face is flat. Information useful for vehicle driving, for example, character information, such as a vehicle speed value and “km/h”, is displayed as necessary on the display face of the display device.

The light including a two-dimensional display image displayed on the display face of the display device 20 is emitted from the display device 20 to the convex mirror 30, reflected by the face of the convex mirror 30 to a concave mirror 50, reflected by the face of the concave mirror 50, and emitted from the opening section 70 as shown in FIG. 1. The light emitted from the opening section 70 is reflected by the face of a windshield WS to an eye point EP. The eye point EP is a point or region in design where the actual viewpoint of the driver is assumed to be present.

Hence, the driver can visually recognize the display image projected by the HUD unit 100 at a position of the eye point EP. The display image 60 to be visually recognized actually by the driver is formed as a virtual image at a predetermined position ahead of the windshield WS. Since the concave mirror 50 optically has a magnification factor, the concave mirror can project the display image to be visually recognized by the driver in a magnified state.

Although the light emitted from the HUD unit 100 is reflected by the face of the windshield WS in the example shown in FIG. 1, an optical reflection member, being referred to as a combiner or a half mirror, may be used instead of the windshield WS.

Next, the optical path of the convex mirror 30 will be described. In the vehicular projection display apparatus 200 shown in FIG. 1, the convex mirror 30 inside the HUD unit 100 has a function of forming a special intermediate image 40 for correcting the three-dimensional image face curvature generated in the display image 60 due to the influence of the curved face of the concave mirror 50 and the shape of the reflecting face on the windshield WS.

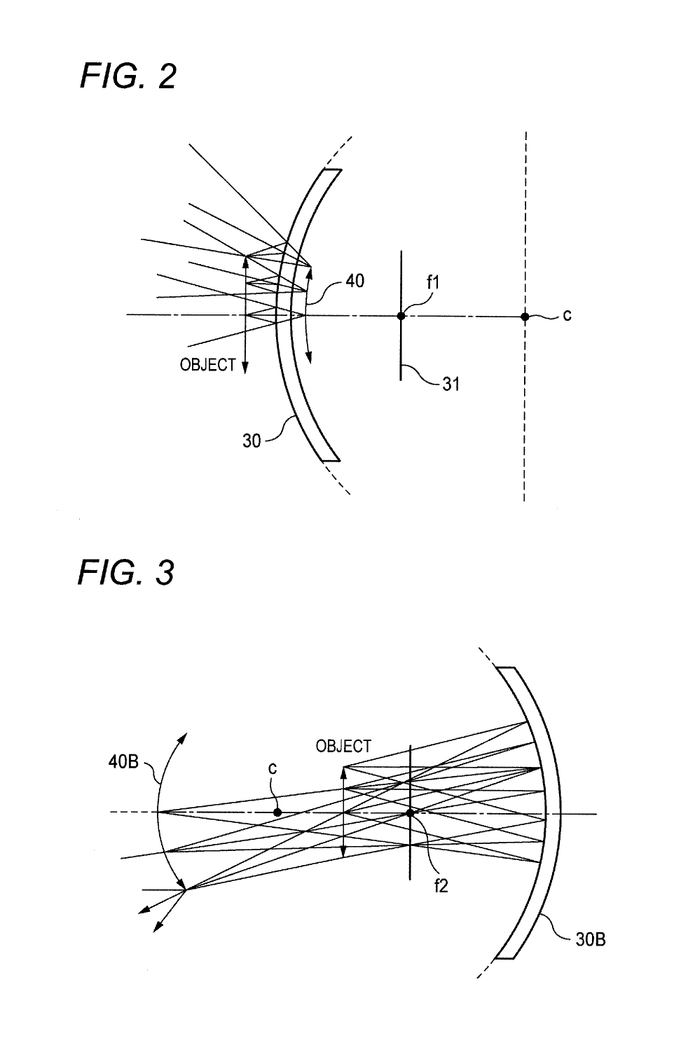

FIG. 2 shows the relationship among the convex mirror 30 shown in FIG. 1, an object and the intermediate image 40. In FIG. 2, point f1 represents the focus of the convex mirror 30, and point c represents the spherical center of the convex mirror 30. Although it is assumed that the convex mirror 30 has a single curvature radius in FIG. 2 for easy understanding of the operation principle of the apparatus, the shape of the mirror may be changed as necessary.

In the case that the face of the display device 20 is flat, since an image is displayed on the flat display face of the display device, a flat optical image enters the convex mirror 30 as shown as an “object” in FIG. 2. In the case that this “object” is close to the convex mirror 30, the intermediate image 40 of the “object” is formed as a virtual image at a position closer to the convex mirror 30 than the focal plane 31 serving as a plane including the focus f1 of the convex mirror 30 and being perpendicular to the optical axis thereof as shown in FIG. 2.

Furthermore, since the reflecting face of the convex mirror 30 is curved, the intermediate image 40 has a curved shape similar to such a shape as obtained by curving the flat face of the “object”. That is to say, like the curved shape of the convex mirror 30, the curved shape of the intermediate image 40 is a shape in which the central section of the curved shape protrudes to the side of the reflecting face of the convex mirror 30 more than the peripheral section thereof.

In the vehicular projection display apparatus 200 shown in FIG. 1, the optical image (virtual image) of the intermediate image 40 formed by the convex mirror 30 is guided to the face of the concave mirror 50 via the convex mirror 30. The intermediate image 40 is curved in the same direction as that of the reflecting face of the concave mirror 50. That is to say, although the central section of the reflecting face of the concave mirror 50 is recessed with respect to the peripheral section thereof, the central section of the intermediate image 40 is curved so as to protrude to the side of the reflecting face of the concave mirror 50 in comparison with the peripheral section thereof.

Next, the image face curvature and the correction thereof will be described. When it is assumed that the special intermediate image 40 shown in FIG. 1 is not formed, in the case that the face of the display device 20 is flat, the image forming position of the display image (virtual image) is a position on a curved face instead of a flat face due to the influence of the shape of the reflecting face of the concave mirror 50 having a curved face. Hence, in the case that the driver visually recognizes the display image 60, the aberration of the image face curvature occurs, and distortion in the depth direction (Z direction) of the optical axis occurs.

On the other hand, in the vehicular projection display apparatus 200 shown in FIG. 1, since the curved intermediate image 40 is formed from the display device 20 by the convex mirror 30, the display image 60 is also affected by the influence of the shape of the intermediate image 40. Furthermore, since the shape of the intermediate image 40 is curved in the same direction as that of the reflecting face of the concave mirror 50, the influence of the shape of the intermediate image 40 is exerted so as to cancel the image face curvature occurring due to the influence of the curved face of the concave mirror 50. That is to say, the display image 60 is formed so as not to be curved but to be flat, whereby the image face curvature is corrected.

In reality, however, the face of the windshield WS is generally curved. Hence, the image face curvature may sometimes occur due to the influence of the curved face of the windshield WS. The curved shape of the intermediate image 40 is thus required to be determined in consideration of both the influence of the concave mirror 50 and the influence of the windshield WS. As a result, the image face curvature due to the influence of the shape of the windshield WS can also be corrected.

Next, the influence of the incident angle of the display device 20 and the improvement in the display quality of the display device will be described.

In the case that the display device 20 shown in FIG. 1 is, for example, a TN liquid crystal display device, its viewing angle is small. Hence, in the case that light fluxes having large emission angles and emitted from the display device are used, the luminance characteristics of the display vary significantly depending on the emission angle, and the display quality is likely to be lowered.

Hence, the display quality can be prevented from being lowered by using only the light fluxes having small emission angles and emitted from the display device 20 even in the case that a display device having a small viewing angle is adopted. In the vehicular projection display apparatus 200 shown in FIG. 1, the characteristics of the optical system and the position at which the convex mirror 30 is disposed have been adjusted beforehand so that the display image (virtual image) 60 is displayed by using only the light fluxes having small emission angles and emitted from the display device.

More specifically, the overall optical path is formed so that the image at the eye point EP passes through, for example, the paths of the light fluxes L1, L2 and L3, is reflected by the face of the windshield WS, and reflected by the face of the concave mirror 50, and then formed as an image 32 in the vicinity of the focal plane 31 including the focus f1 of the convex mirror 30.

Consequently, among the light fluxes emitted from the display device 20, only the light fluxes having small emission angles are used for the image to be visually recognized by the driver at the position of the eye point EP due to the influence of the optical characteristics of the convex mirror 30. Hence, even in the case that a display device having a small viewing angle is adopted, the variation in luminance characteristics can be suppressed and the deterioration in display quality, such as degradation in contrast, can be prevented.

<Modification 1>

FIG. 3 shows the positional relationship among a concave mirror 30B to be used in Modification 1, an object and an intermediate image. That is to say, in Modification 1, the concave mirror 30B shown in FIG. 3 is used instead of the convex mirror 30 shown in FIG. 1.

Moreover, in Modification 1, an optical path is formed so that the display device 20 corresponding to the “object” shown in FIG. 3 is disposed at a position farther away from the reflecting face of the concave mirror 30B than the focal plane including the focus f2 of the concave mirror 30B as shown in FIG. 3. Point c in FIG. 3 represents the spherical center of the reflecting face of the convex mirror 30B.

In Modification 1, as shown in FIG. 3, an intermediate image 40B is formed as a real image at a position farther away from the reflecting face of the concave mirror 30B than the focus f2 of the concave mirror 30B. The light fluxes of the intermediate image 40B, i.e., the real image, are guided to the concave mirror 50 shown in FIG. 1 and the light fluxes of the display image are further guided to the eye point EP via the reflecting face of the concave mirror 50 and the face of the windshield WS.

The intermediate image 40B, i.e., the real image, is curved in the direction opposite to that of the reflecting face of the concave mirror 30B as shown in FIG. 3. Hence, in the case that the concave mirror 30B is disposed instead of the convex mirror 30 shown in FIG. 1, the intermediate image 40B curved in the same direction as that of the reflecting face of the concave mirror 50 is formed at the position corresponding to the intermediate image 40 shown in FIG. 1.

Hence, also in Modification 1, as in the case of the configuration shown in FIG. 1, the image face curvature occurring due to the curved face shape of the reflecting face of the concave mirror 50 can be canceled by the curved shape of the intermediate image 40B. In addition, also in Modification 1, as in the case of the configuration shown in FIG. 1, the variation in luminance characteristics in the display image 60 can be suppressed and the deterioration in display quality, such as degradation in contrast, can be prevented by forming an optical path so that the image 32 at the eye point EP is formed in the vicinity of the focal plane 31 of the concave mirror 30B.

<Modification 2>

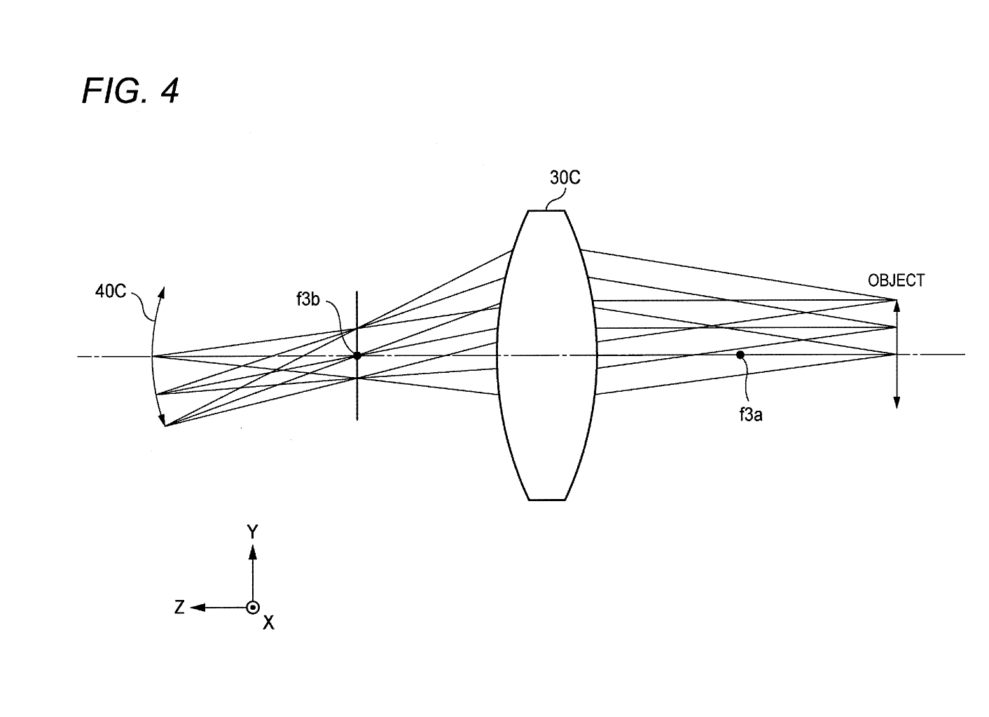

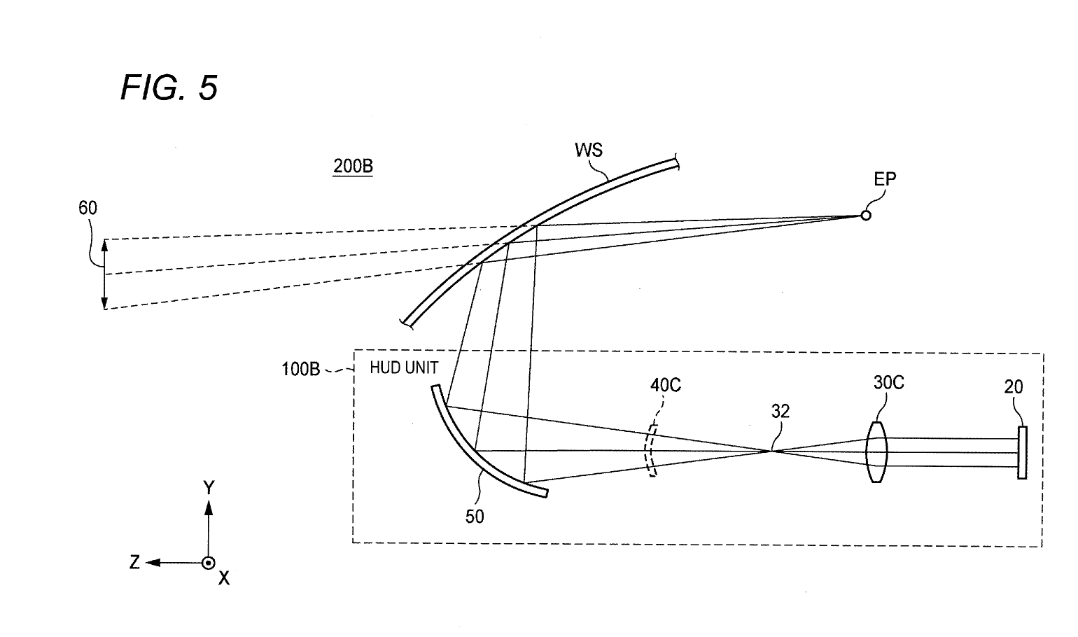

FIG. 4 shows the positional relationship among a convex lens 30C to be used in Modification 2, an object and an intermediate image. Furthermore, FIG. 5 shows the optical path of a vehicular projection display apparatus according to Modification 2.

That is to say, in Modification 2, the convex lens 30C shown in FIG. 4 is used instead of the convex mirror 30 shown in FIG. 1, and an optical path is formed as shown in FIG. 5. Both the faces of the convex lens 30C may have a convex shape, or one of the faces thereof may have a convex shape and the other face may have a flat shape.

Moreover, in Modification 2, the optical path is formed as shown in FIG. 5 so that the display device 20 corresponding to the “object” shown in FIG. 4 is disposed at a position farther away from the convex lens 30C than the focal plane including the focus f3a of the convex lens 30C as shown in FIG. 4.

In Modification 2, as shown in FIG. 4, an intermediate image 40C is formed as a real image at a position farther away from the convex mirror 30C than the focus f3b of the convex lens 30C. The light fluxes of the intermediate image 40C, i,e., the real image, are guided to the concave mirror 50 shown in FIG. 5 and the light fluxes of the display image are further guided to the eye point EP via the reflecting face of the concave mirror 50 and the face of the windshield WS.

The intermediate image 40C, i.e., the real image, is curved in the same direction as that of the reflecting face of the concave mirror 50 as shown in FIGS. 4 and 5. That is to say, the intermediate image 40C curved in the same direction as that of the reflecting face of the concave mirror 50 is formed at the position shown in FIG. 5.

Hence, also in Modification 2, as in the case of the configuration shown in FIG. 1, the image face curvature occurring due to the curved shape of the reflecting face of the concave mirror 50 can be canceled by the curved shape of the intermediate image 40C. In addition, also in Modification 2, as in the case of the configuration shown in FIG. 1, the variation in luminance characteristics in the display image 60 can be suppressed and the deterioration in display quality, such as degradation in contrast, can be prevented by forming an optical path so that the image 32 at the eye point EP is formed in the vicinity of the focal plane of the convex lens 30C.

In the configuration shown in FIG. 5, in the case that the display device 20 is disposed so that its display face is closer to the convex lens 30C than the focal plane of the convex lens 30C, an intermediate image, i.e., a curved virtual image, can be formed at a position between the convex lens 30C and the display device, and the image face curvature can be reduced as in the case of the configuration shown in FIG. 1 by guiding the optical image of the intermediate image to the concave mirror 50. However, in the case that the convex lens 30C is located close to the display device, since light fluxes having large emission angles and emitted from the display device are used, the contrast may be degraded.

As described above, in all of the configurations shown in FIG. 1 and described in Modification 1 and Modification 2, the three-dimensional distortion of the image face curvature occurring due to the shapes of the reflecting faces of the concave mirror 50 and the windshield WS can be reduced, whereby the display quality of the display image (virtual image) 60 to be visually recognized can be improved. In addition, in the case that the optical path is formed so that the image 32 at the eye point position is formed in the vicinity of the focal plane 31 of the convex lens 30 or the like for forming an intermediate image, only the light fluxes having small emission angles and emitted from the display device can be used for the display of the display image 60, whereby the deterioration in display quality can be prevented even in the case that a display device having a small viewing angle is used.

The vehicular projection display apparatus according to embodiments of the present invention described above will be briefly summarized and listed in the following items [1] to [5].

[1] A vehicular projection display apparatus including:

an intermediate image forming optical member (convex mirror 30, concave mirror 30B or convex lens 30C) including at least one of an optical lens, a convex mirror and a concave mirror and having a face for transmitting or reflecting light;

a display device (20) disposed to project light including a display image to the intermediate image forming optical member, and to form an intermediate image (40, 40B, 40C) of the display image as a virtual image at a position closer to the intermediate image forming optical member than a focus (f1) of the intermediate image forming optical member or to form the intermediate image as a real image at a position farther away from the intermediate image forming optical member than the focus (f2, f3) of the intermediate image forming optical member, and

an HUD optical system (concave mirror 50) which receives the light of the intermediate image formed by the intermediate image forming optical member via the intermediate image forming optical member, which guides the light to a reflecting face of a windshield of a vehicle or a light reflecting member in a vicinity of the windshield, and which projects the light to allow the display image of the light reflected by the reflecting face to be visually recognized as a virtual image at a predetermined eye point,

wherein the intermediate image forming optical member forms the intermediate image in a state in which at least part of the intermediate image is curved from a flat plane with respect to the display device.

[2] The vehicular projection display apparatus according to the above-mentioned item [1],

wherein the HUD optical system includes a concave mirror (concave mirror 50) which magnifies an image to be projected,

wherein the intermediate image forming optical member includes a convex mirror (convex mirror 30) having a shape in which a central portion of a face opposing a concave face of the concave mirror of the HUD optical system protrudes with respect to a peripheral portion thereof, and the intermediate image (40) formed by the intermediate image forming optical member is a virtual image, and

wherein a curved state of the intermediate image has a shape which corrects an aberration of image face curvature occurring due to an influence of at least one of the curved face included in the HUD optical system and a face shape of the windshield of the vehicle.

[3] The vehicular projection display apparatus according to the above-mentioned item [1],

wherein the HUD optical system includes a first concave mirror (concave mirror 50) which magnifies an image to be projected,

wherein the intermediate image forming optical member includes a second convex mirror (convex mirror 30B) having a shape in which a peripheral portion of a face opposing a concave face of the first concave mirror protrudes more than a central portion thereof, and the intermediate image (40B) formed by the intermediate image forming optical member is a real image, and

wherein a curved state of the intermediate image has a shape which corrects an aberration of image face curvature occurring due to an influence of at least one of a curved face included in the HUD optical system and a face shape of the windshield of the vehicle.

[4] The vehicular projection display apparatus according to the above-mentioned item [1],

wherein the HUD optical system includes a concave mirror (concave mirror 50) which magnifies an image to be projected,

wherein the intermediate image forming optical member includes one or more convex faces (convex lens 30C) having a shape in which a central portion thereof protrudes more than a peripheral portion thereof, and the intermediate image (40C) formed by the intermediate image forming optical member is a real image, and

wherein a curved state of the intermediate image has a shape which corrects an aberration of image face curvature occurring due to an influence of at least one of a curved face included in the HUD optical system and a face shape of the windshield of the vehicle.

[5] The vehicular projection display apparatus according to any one of the above-mentioned items [1] to [4],

wherein a position in which the intermediate image forming optical member is disposed and an optical characteristics of the intermediate image forming optical member are determined such that the image (32) formed at the position of the eye point via the optical system including a reflecting face of the windshield or in the vicinity thereof, the HUD optical system, and the intermediate image forming optical member is disposed in the vicinity of a plane (focal plane 31) including the focus of the intermediate image forming optical member.

What is claimed is:

1. A vehicular projection display apparatus comprising:
an intermediate image forming optical member comprising at least one of an optical lens, a convex mirror and a concave mirror and having a face for transmitting or reflecting light;
a display device disposed to project light comprising a display image to the intermediate image forming optical member, and to form an intermediate image of the display image as a virtual image at a position closer to the intermediate image forming optical member than a focus of the intermediate image forming optical member or to form the intermediate image as a real image at a position farther away from the intermediate image forming optical member than the focus of the intermediate image forming optical member, and
an HUD optical system which receives the light of the intermediate image formed by the intermediate image forming optical member via the intermediate image forming optical member, which guides the light to a reflecting face of a windshield of a vehicle or a light reflecting member in a vicinity of the windshield, and which projects the light to allow the display image of the light reflected by the reflecting face to be visually recognized as a virtual image at a predetermined eye point,
wherein the intermediate image forming optical member forms the intermediate image in a state in which at least part of the intermediate image is curved from a flat plane with respect to the display device.

2. The vehicular projection display apparatus according to claim 1,
wherein the HUD optical system comprises a concave mirror which magnifies an image to be projected,
wherein the intermediate image forming optical member comprises a convex mirror having a shape in which a central portion of a face opposing a concave face of the concave mirror of the HUD optical system protrudes with respect to a peripheral portion thereof, and the intermediate image formed by the intermediate image forming optical member is a virtual image, and
wherein a curved state of the intermediate image has a shape which corrects an aberration of image face curvature occurring due to an influence of at least one of the curved face included in the HUD optical system and a face shape of the windshield of the vehicle.

3. The vehicular projection display apparatus according to claim 1,
wherein the HUD optical system comprises a first concave mirror which magnifies an image to be projected,
wherein the intermediate image forming optical member comprises a second convex mirror having a shape in which a peripheral portion of a face opposing a concave face of the first concave mirror protrudes more than a central portion thereof, and the intermediate image formed by the intermediate image forming optical member is a real image, and
wherein a curved state of the intermediate image has a shape which corrects an aberration of image face curvature occurring due to an influence of at least one of a curved face included in the HUD optical system and a face shape of the windshield of the vehicle.

4. The vehicular projection display apparatus according to claim 1,
wherein the HUD optical system comprises a concave mirror which magnifies an image to be projected,
wherein the intermediate image forming optical member comprises one or more convex faces having a shape in which a central portion thereof protrudes more than a peripheral portion thereof, and the intermediate image formed by the intermediate image forming optical member is a real image, and
wherein a curved state of the intermediate image has a shape which corrects an aberration of image face curvature occurring due to an influence of at least one of a curved face included in the HUD optical system and a face shape of the windshield of the vehicle.

5. The vehicular projection display apparatus according to claim 1,
wherein a position in which the intermediate image forming optical member is disposed and an optical characteristics of the intermediate image forming optical member are determined such that the image formed at the position of the eye point via the optical system comprising a reflecting face of the windshield or in the vicinity thereof, the HUD optical system, and the intermediate image forming optical member is disposed in the vicinity of a plane comprising the focus of the intermediate image forming optical member.
